(19) United States
(12) Patent Application Publication
(10) Pub. No.: US 2025/0038451 A1
(43) Pub. Date: Jan. 30, 2025

(54) ELECTRICAL CONNECTOR FOR CIRCUIT BOARDS

(71) Applicant: Hirose Electric Co., Ltd., Yokohama (JP)

(72) Inventors: Yoshitaka HAYAKAWA, Yokohama (JP); Nobuhiro TAMAI, Yokohama (JP)

(21) Appl. No.: 18/786,095

(22) Filed: Jul. 26, 2024

(30) Foreign Application Priority Data
Jul. 28, 2023 (JP) 2023-123122

(51) Int. Cl. H01R 13/502; H01R 12/71

(52) U.S. Cl. CPC H01R 13/5025; H01R 12/71

(57) ABSTRACT

To provide an electrical connector for circuit boards capable of implementing a good impedance match while permitting relative movement of the movable housing with respect to the stationary housing. The connector has a dielectric member 40, which is disposed in the interior space formed in the stationary housing 20 and is attached to the movable housing 30, the dielectric member 40 has contoured portions 42A, which are spaced by a clearance from the intermediate portions 15 of the terminals 10 and extend along the intermediate portions 15, and the contoured portions 42A are capable of following the intermediate portions 15 when the intermediate portions 15 are resiliently deformed in the connector width direction perpendicular to the terminal array direction.

### CROSS-REFERENCE TO RELATED APPLICATIONS

This application claims priority to Japanese Patent Application No. 2023-123122, filed Jul. 28, 2023, the contents of which are incorporated herein by reference in its entirety for all purposes.

### BACKGROUND

### Technical Field

The present invention relates to an electrical connector for circuit boards disposed on a mounting face of a circuit board.

### Related Art

Known electrical connectors for circuit boards of this type include, for example, the electrical connector of Patent Document 1. In the electrical connector of Patent Document 1, multiple terminals, which are arranged such that the terminal array direction is a direction parallel to a mounting face of a circuit board, are provided spanning between a stationary housing and a movable housing, which are separate pieces. The stationary housing is secured to the circuit board through the medium of the terminals. The movable housing is adapted to be capable of relative movement with respect to the stationary housing due to resilient deformation of the terminals.

The terminals, which are made by bending metal strip-like pieces in the through-thickness direction, are adapted to be solder connectable to the mounting face of the circuit board with the help of connecting portions formed at the bottom ends thereof while being adapted to be capable of contacting counterpart terminals provided in a counterpart connector with the help of contact portions formed at the top ends thereof. In addition, stationary-side retained portions retained in the stationary housing, movable-side retained portions retained in the movable housing, and deformation portions coupling the stationary-side retained portions and the movable-side retained portions are provided between the connecting portions and the contact portions.

The deformation portions, which extend between the two housings without being retained in the stationary housing or in the movable housing, permit movement of the movable housing due to resilient deformation of said deformation portions. The deformation portions are covered by impedance matching portions made of dielectric material. The impedance matching portions are formed by integral molding with the deformation portions in contact with the outer surface of said deformation portions and are adapted to be resiliently deformable along with said deformation portions. In Patent Document 1, covering the deformation portions with the impedance matching portions in this manner adjusts the impedance of the terminals and, as a result, achieves an impedance match.

### PATENT DOCUMENTS

### [Patent Document 1]

Japanese Patent Application Publication No. 2014-222576.

### SUMMARY

### Problems to be Solved

In Patent Document 1, the impedance matching portions are formed in contact with the deformation portions of the terminals. When the impedance matching portions made of dielectric material are placed in contact with the deformation portions in this manner, there is a risk that the impedance of said deformation portions will drop too low and an impedance match in the terminals will be difficult to achieve.

With such circumstances in mind, it is an object of the present invention to provide an electrical connector for circuit boards capable of implementing a good impedance match while permitting relative movement of the movable housing with respect to the stationary housing.

### Means for Solving the Problems

(1) The inventive electrical connector for circuit boards is an electrical connector for circuit boards disposed on a mounting face of a circuit board, said connector having a plurality of terminals arranged such that the terminal array direction is a direction parallel to the mounting face, a stationary housing secured to the circuit board through the medium of the terminals, and a movable housing capable of relative movement with respect to the stationary housing, wherein the terminals have a stationary-side retained portion retained in the stationary housing, a movable-side retained portion retained in the movable housing, and a resiliently deformable intermediate portion located between the stationary-side retained portion and the movable-side retained portion, and are provided spanning between the stationary housing and the movable housing.

In the present invention, such an electrical connector for circuit boards is characterized by the fact that said connector has a dielectric member that is at least partially disposed in an interior space formed in at least one of the stationary housing and the movable housing and is attached to the stationary housing or the movable housing, the dielectric member has contoured portions extending along the intermediate portions while being spaced by a clearance from the intermediate portions, and the contoured portions are adapted to be capable of following the intermediate portions when the intermediate portions are resiliently deformed in the connector width direction perpendicular to the terminal array direction.

In the present invention, the dielectric member attached to the movable housing has contoured portions extending along the intermediate portions of the terminals while being spaced by a clearance from said intermediate portions. The fact that the contoured portions of the dielectric member extend along the intermediate portions in this manner makes it possible to adjust the characteristic impedance of said intermediate portions and, as a result, achieve a characteristic impedance match in the terminals. At such time, the contoured portions are positioned spaced by a clearance from the intermediate portions and, therefore, are not in contact with said intermediate portions. Accordingly, the characteristic impedance of the intermediate portions does not drop too low, and a good characteristic impedance match is therefore easy to achieve. In addition, since the contoured portions are adapted to be capable of following the intermediate portions, the resilient deformation of the intermediate portions and, by extension, the movement of the movable housing are not impeded.

(2) In the invention of (1), the dielectric member may be attached to the movable housing, and may have restricted portions abuttable against the stationary housing in the connector width direction at locations other than the contoured portions.

With such an arrangement, when the movable housing moves in the connector width direction, the restricted portions of the dielectric member abut the stationary housing, as a consequence of which the movement in concert with the movable housing is restricted. As a result, the contoured portions of the dielectric member are displaced using the locations of abutment of the restricted portions and the stationary housing as fulcrum points and, consequently, follow the movement of the movable housing along with the intermediate portions of the terminals. As a result, it becomes easier to maintain an assured clearance between the contoured portions and the intermediate portions and, by extension, a good characteristic impedance match even after the movement of the movable housing.

(3) In the inventions of (1) or (2), the dielectric member may have no sections abutting the stationary housing in the terminal array direction, and the dielectric member as a whole may be capable of moving in the terminal array direction along with the movable housing.

With such an arrangement, the dielectric member as a whole can smoothly follow the movement of the movable housing without interfering with the stationary housing when the movable housing moves in the terminal array direction.

### Technical Effect

The present invention can provide an electrical connector for circuit boards capable of implementing a good characteristic impedance match while permitting relative movement of the movable housing with respect to the stationary housing.

### BRIEF DESCRIPTION OF DRAWINGS

FIG. 1 is a perspective view of a socket connector and a plug connector according to a first embodiment of the present invention, shown in a state before mating connection.

FIG. 2 is a perspective view illustrating the respective components of the socket connector of FIG. 1 in isolation.

FIG. 3 is a cross-sectional view illustrating a cross-section of the socket connector and plug connector of FIG. 1 taken in a plane perpendicular to the terminal array direction, shown in a state before mating connection.

FIGS. 4 (A) and 4 (B) are cross-sectional views illustrating attachment of the dielectric member to the movable housing, where FIG. 4 (A) shows a state before attachment, and FIG. 4 (B) shows a state after attachment.

FIG. 5 is a cross-sectional view illustrating a cross-section of the socket connector and plug connector taken in a plane perpendicular to the terminal array direction, shown in a state after mating connection.

FIG. 6 is a cross-sectional view illustrating a cross-section of the socket connector and plug connector taken in a plane perpendicular to the terminal array direction, shown in a floating state after mating connection.

FIG. 7 is a cross-sectional view illustrating a cross-section of a socket connector according to a second embodiment of the present invention taken in a plane perpendicular to the connector width direction.

FIG. 8 is a cross-sectional view illustrating a cross-section of a socket connector according to a third embodiment of the present invention taken in a plane perpendicular to the terminal array direction.

FIG. 9 is a cross-sectional view illustrating a cross-section of the socket connector according to a fourth embodiment of the present invention taken in a plane perpendicular to the terminal array direction.

### DETAILED DESCRIPTION

Embodiments of the present invention are described hereinbelow with reference to the accompanying drawings.

### First Embodiment

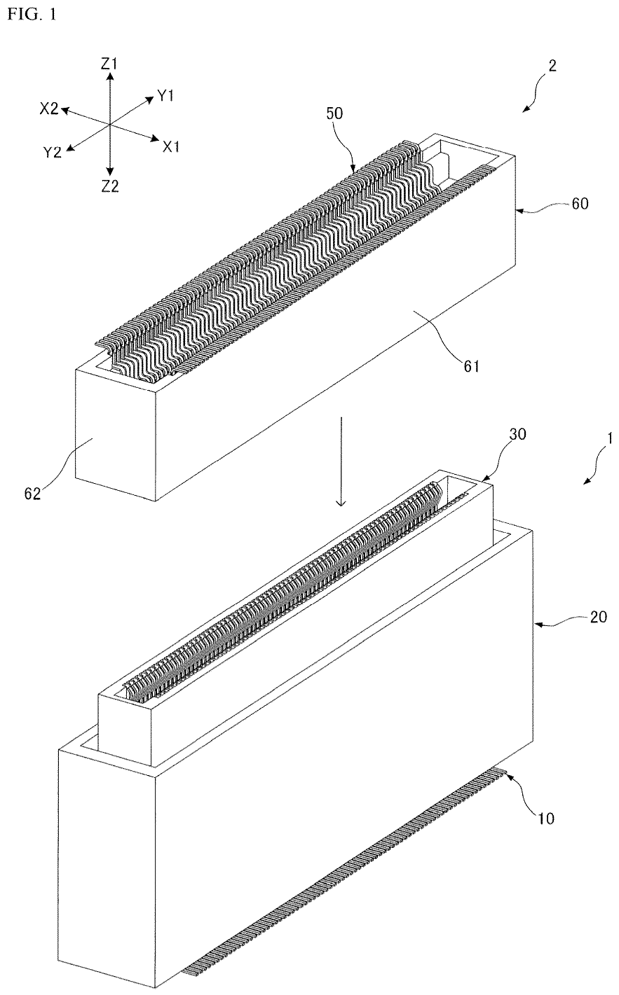

FIG. 1 is a perspective view of a socket connector 1 and a plug connector 2 according to the present embodiment, shown in a state before mating connection. The socket connector 1 is an electrical connector for circuit boards mounted to a mounting face of a circuit board (not shown). In addition, the plug connector 2, which serves as a counterpart connect body (counterpart connector) connected to the socket connector 1, is an electrical connector for circuit boards mounted to a mounting face of another circuit board (not shown). The socket connector 1 and plug connector 2 are matingly connected in the connector height direction (in the up-down direction designated as the Z-axis direction) perpendicular to the mounting faces in an orientation wherein the mounting faces of the circuit boards are in an opposed relationship, and thus form an electrical connector assembly. In the present embodiment, the plug connector 2 is adapted to be matingly connected to the socket connector 1 from above.

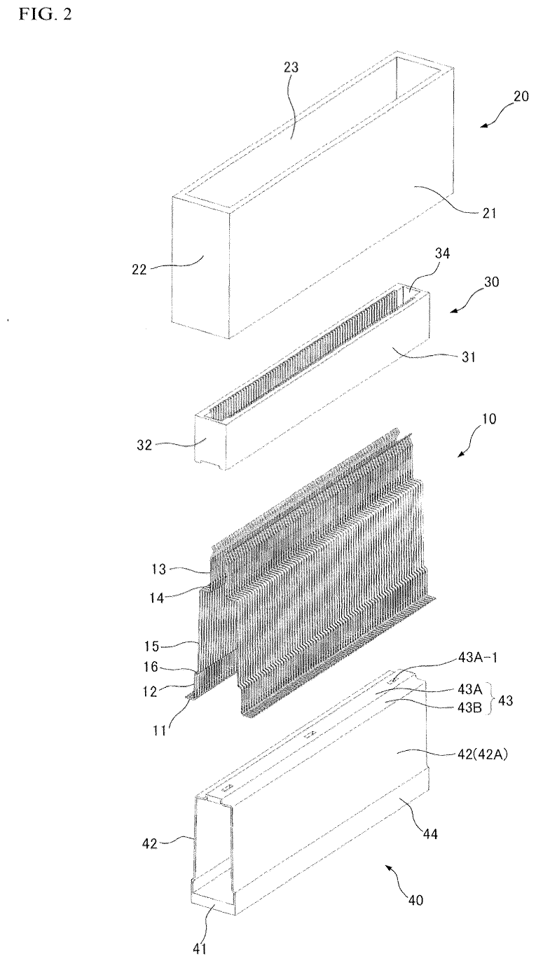

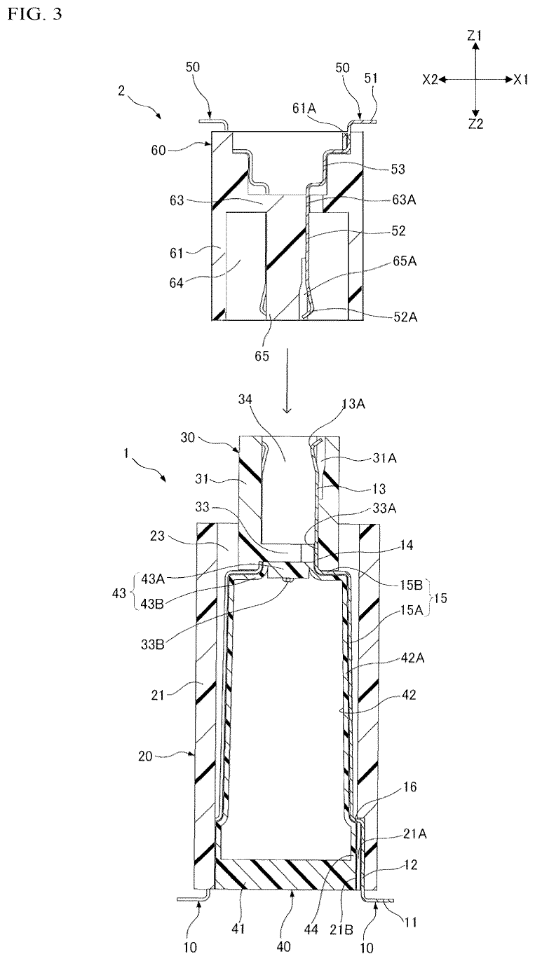

The socket connector 1 has multiple socket terminals 10 made of sheet metal, which are arranged side by side such that the terminal array direction is a direction parallel to the mounting face of the circuit board (Y-axis direction), socket housings 20, 30 (the stationary housing 20 and the movable housing 30 described below) made of plastic or other dielectric material (made of electrically insulating material), which retain the multiple socket terminals 10, and a dielectric member 40 (see FIG. 2 and FIG. 3) made of plastic or other dielectric material, which is attached to the movable housing 30. Polyamide (PA) or liquid crystal polymers (LCP) and other engineering plastics, etc., are suggested as examples of the dielectric material comprising the socket housings 20, 30. In addition, polyamide (PA) or liquid crystal polymers (LCP) and other engineering plastics, elastomers, rubbers, and the like are suggested as examples of the dielectric material comprising the dielectric member 40.

FIG. 2 is a perspective view illustrating the respective components of the socket connector 1 in isolation. FIG. 3 is a cross-sectional view illustrating a cross-section of the socket connector 1 and plug connector 2 before mating connection taken in a plane perpendicular to the terminal array direction at the location of the socket terminals 10. As shown in FIG. 2 and FIG. 3, the socket terminals 10 are arranged in two rows. The two rows of the socket terminals 10 are provided in mutually symmetrical orientations in the connector width direction (X-axis direction) perpendicular to both the terminal array direction (Y-axis direction) and the up-down direction (Z-axis direction). In addition, in the present embodiment, the two rows of the socket terminals 10 are disposed in a staggered pattern, with the socket terminals 10 in one row and the socket terminals 10 in the other row being positioned differently from each other in the terminal array direction.

The socket housings 20, 30 include a stationary housing 20 secured to the circuit board (not shown) through the medium of the socket terminals 10, and a movable housing 30 capable of relative movement with respect to the stationary housing 20. The socket terminals 10 are provided spanning between the stationary housing 20 and the movable housing 30.

The socket terminals 10 are made by bending metal strip-like pieces in the through-thickness direction thereof and, as shown in FIG. 2, are disposed such that the terminal width direction (direction perpendicular to the through-thickness direction of the socket terminals 10) thereof coincides with the terminal array direction (Y-axis direction). As shown in FIG. 2 and FIG. 3, the socket terminals 10 have a connecting portion 11 formed at one end located at the bottom, a stationary-side retained portion 12 extending upwardly from the connecting portion 11, a contact arm portion 13 formed at the other end located upwardly and inwardly of the connecting portion 11 in the connector width direction, a movable-side retained portion 14 extending downwardly from the contact arm portion 13, and an intermediate portion 15 and a transitional portion 16 located between the stationary-side retained portion 12 and the movable-side retained portion 14.

The configuration of the stationary housing 20 and the movable housing 30 will be described before further description of the socket terminals 10. As shown in FIG. 1 and FIG. 2, the stationary housing 20 has a rectangular cylindrical configuration with a rectangular parallelepiped-like external shape whose longitudinal direction is the terminal array direction (Y-axis direction). The stationary housing 20 has a pair of lateral walls 21, which extend in the terminal array direction and a pair of end walls 22, which extend in the connector width direction (X-axis direction) and couple the end portions of the pair of lateral walls 21, with the pair of lateral walls 21 and the pair of end walls 22 forming a peripheral wall. As shown in FIG. 3, an interior space 23, which is enclosed by this peripheral wall and is disposed in the up-down direction, accommodates a portion of the movable housing 30, a portion of the socket terminals 10, and the dielectric member 40.

As shown in FIG. 3, groove-shaped stationary-side retaining portions 21A, which are recessed from the interior wall surface of said lateral walls 21 while extending in the up-down direction, are formed in the bottom portion of the lateral walls 21. The stationary-side retaining portions 21A, whose bottom ends are open, are adapted to retain the stationary-side retained portions 12 of the socket terminals 10 press-fitted from below. In addition, in the bottom portion of these lateral walls 21, sections located on both sides of each stationary-side retaining portion 21A in the terminal array direction form restricting portions 21B intended for restricting the movement of the dielectric member 40 in the connector width direction in excess of a predetermined distance.

As shown in FIG. 3, the movable housing 30 is inserted and disposed in the interior space 23 of the stationary housing 20 from below, and the lower portion of the movable housing 30 is accommodated in the top portion of the interior space 23. As shown in FIG. 2, the movable housing 30 has a pair of long walls 31 extending in the terminal array direction, a pair of short walls 32 extending in the connector width direction and coupling the end portions of the pair of long walls 31, and a bottom wall 33 (see FIG. 3) sealing the space enclosed by the peripheral wall made up of the pair of long walls 31 and the pair of short walls 32 from below. The upwardly open space enclosed by the aforementioned peripheral wall forms a socket-side receiving portion 34 intended for receiving a portion of the plug connector 2.

As shown in FIG. 3, socket terminal groove portions 31A recessed from the interior wall surface of said long walls 31 are formed in a side-by-side arrangement in the top portion of the long walls 31. The socket terminal groove portions 31A, which extend in the up-down direction along the top portions of the contact arm portions 13 of the socket terminals 10, are enabled to permit resilient deformation of the top portions of said contact arm portions 13.

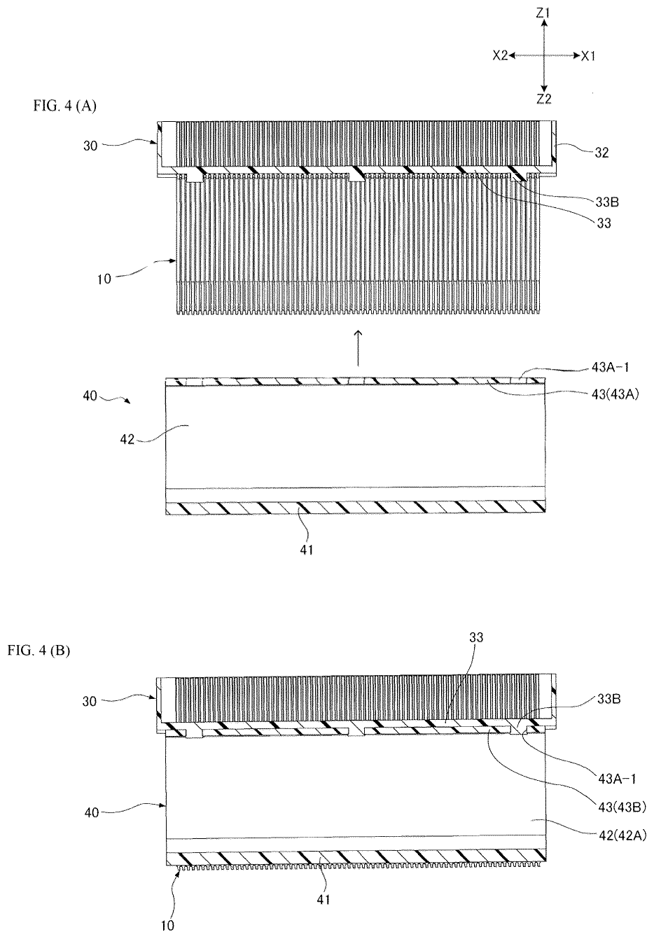

As shown in FIG. 3, movable-side retaining portions 33A intended for press-fittingly retaining the movable-side retained portions 14 of the socket terminals 10 are formed in the bottom wall 33 as aperture portions disposed through the bottom wall 33 in the up-down direction. In addition, the bottom wall 33 has attachment protrusions 33B intended for attaching the dielectric member 40 at multiple locations (3 locations in the present embodiment) in the terminal array direction (see also FIGS. 4 (A, B)). The attachment protrusions 33B, which are located at the center in the connector width direction, protrude from the bottom face of the bottom wall 33 in a rectangular columnar configuration.

Going back to the description of the socket terminals 10, as can be seen in FIG. 3, the connecting portions 11, which extend outwardly in the connector width direction at locations downward of the bottom face of the stationary housing 20, are adapted to be solder-connected to corresponding circuits (not shown) on the mounting face of the circuit board. The stationary-side retained portions 12, which are bent at the inward ends of the connecting portions 11 in the connector width direction and extend upwardly in a rectilinear configuration, are press-fittingly retained by the stationary-side retaining portions 21A of the stationary housing 20 with the help of press-fitting projections formed on opposite side edges (edges extending in the up-down direction on opposite sides in the terminal width direction).

The top portions of the contact arm portions 13, which extend in the up-down direction along the interior wall surfaces of the long walls 31 of the movable housing 30, are adapted to be resiliently deformable in the connector width direction (in the through-thickness direction of the contact arm portions 13). Specifically, as shown in FIG. 3, the bottom portions of the contact arm portions 13, which are in surface contact with the interior wall surfaces of the long walls 31, are supported by said interior wall surfaces from the outside in the connector width direction. As shown in FIG. 3, the top portions of the contact arm portions 13 are positioned in alignment with the socket terminal groove portions 31A of the long walls 31 in the up-down direction, and resilient deformation thereof directed outwardly in the connector width direction is permitted by the socket terminal groove portions 31A when placed in contact with plug terminals 50, i.e., the counterpart terminals. Contact portions 13A intended for contacting the plug terminals 50 are formed by being bent so as to protrude inwardly in the connector width direction at the top ends of the contact arm portions 13.

As shown in FIG. 3, the movable-side retained portions 14, which extend downwardly from the bottom ends of the contact arm portions 13 in a rectilinear configuration, are retained by the bottom wall 33 of the movable housing 30. Specifically, the movable-side retained portions 14 are press-fittingly retained by the movable-side retaining portions 33A of the movable housing 30 with the help of press-fitting projections formed on opposite side edges (edges extending in the up-down direction on opposite sides in the terminal width direction).

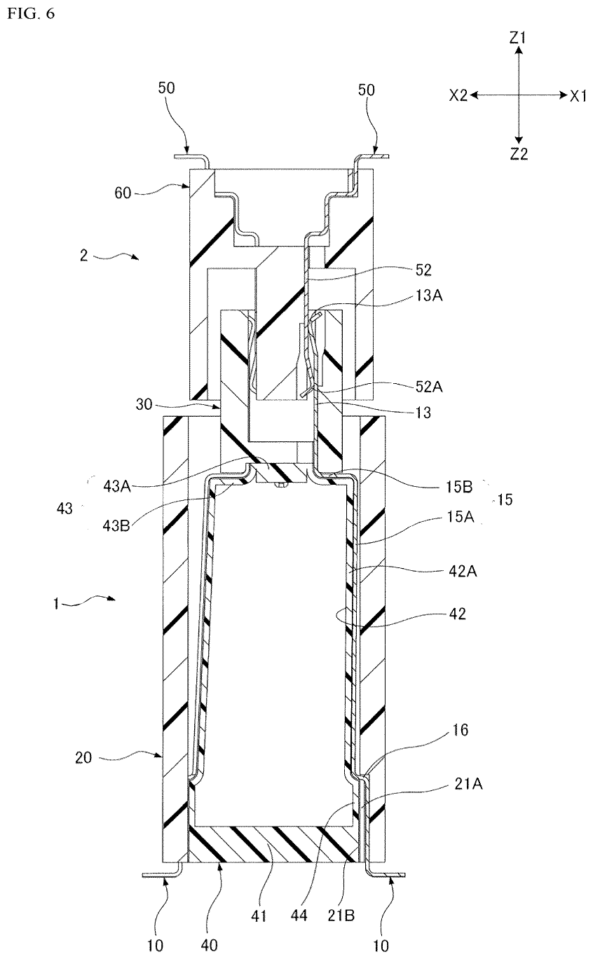

The overall shape of the intermediate portions 15, which have a first leg portion 15A extending in the up-down direction and a second leg portion 15B extending in the connector width direction, is generally an inverted L-shaped configuration. The first leg portions 15A, which extend in a rectilinear configuration along the interior wall surfaces of the lateral walls 21 of the stationary housing 20, are adapted to be resiliently deformable in the connector width direction. The movement (floating) of the movable housing 30 in the connector width direction is permitted due to resilient deformation of these first leg portions 15A (see FIG. 6). The first leg portions 15A are coupled to the top ends of the stationary-side retained portions 12 through the medium of transitional portions 16 extending outwardly from the bottom ends thereof in the connector width direction. As shown in FIG. 3, the first leg portions 15A are provided in positions spaced by a clearance from the interior wall surfaces of the lateral walls 21 in the connector width direction.

In addition, the first leg portions 15A are also adapted to be resiliently deformable in the terminal array direction. The movement (floating) of the movable housing 30 in the terminal array direction is permitted due to resilient deformation of the first leg portions 15A.

The second leg portions 15B, which are bent at right angles at the top ends of the first leg portions 15A and extend inwardly in the connector width direction, are coupled to the bottom ends of the movable-side retained portions 14. The second leg portions 15B extend along the bottom face (lower face) of the bottom wall 33 of the movable housing 30 in a rectilinear configuration.

The dielectric member 40, which is attached to the movable housing 30 from below and disposed within the interior space 23 of the stationary housing 20 (see FIG. 3), is positioned to comprise the terminal array range of all socket terminals 10 in the terminal array direction (see FIG. 4 (B)). As shown in FIG. 2 and FIG. 3, the dielectric member 40 has a plate-shaped bottom plate portion 41 extending in the terminal array direction in an opposed relationship to the mounting face (not shown) of the circuit board, lateral plate portions 42 extending upwardly from opposite ends of the bottom plate portion 41 in the connector width direction, and an upper plate portion 43 coupling the top ends of the two lateral plate portions 42 and extending in the terminal array direction. In the present embodiment, the bottom plate portion 41, lateral plate portions 42, and upper plate portion 43 are devoid of intermittent sections in the terminal array direction, i.e., are continuously solid over the entire extent thereof in the terminal array direction.

As shown in FIG. 3, the bottom plate portion 41 is located in the bottom portion of the interior space 23 of the stationary housing 20 and the bottom face (lower face) thereof is positioned at the same height as the bottom face of the stationary housing 20. The lateral faces of the bottom plate portion 41 (faces located at opposite ends in the connector width direction) are in an opposed relationship to the interior wall surfaces of the interior space 23, i.e., the interior wall surfaces of the restricting portions 21B, while having a slight clearance from said interior wall surfaces in the connector width direction.

The lateral plate portions 42, which are provided over the same range as the bottom plate portion 41 in the terminal array direction, have a thin plate-like configuration whose through-thickness direction is the connector width direction. The bottom portions of the lateral plate portions 42, which are located slightly outwardly of other parts of the lateral plate portions 42 in the connector width direction, are in an opposed relationship to the interior wall surfaces of the interior space 23, i.e., the interior wall surfaces of the restricting portions 21B, while having a slight clearance from said interior wall surfaces in the connector width direction. The lateral faces of the bottom portions of the lateral plate portions 42 and the lateral faces of the bottom plate portion 41, which are formed at the same location in the connector width direction, form a single flat surface. In the present embodiment, the bottom portions of the lateral plate portions 42 and the lateral portions of the bottom plate portion 41, i.e., the sections forming the aforementioned single flat surface, serve as restricted portions 44 abuttable against the restricting portions 21B of the stationary housing 20.

The sections of the lateral plate portions 42 extending upwardly from the aforementioned bottom portions are formed as first contoured portions 42A resiliently deformable in the connector width direction. The first contoured portions 42A, which are positioned spaced by a slight clearance from the interior side faces (major faces located inwardly in the connector width direction) of the first leg portions 15A of the intermediate portions 15 of the socket terminals 10 in the connector width direction, extend along said first leg portions 15A in the up-down direction. The clearance between the first contoured portions 42A and the first leg portions 15A is dimensioned to assure appropriate impedance in the socket terminals 10. Here, the value of the “appropriate impedance” is set within a predetermined allowable range and, accordingly, the aforementioned dimensions are set within a predetermined allowable range. The first contoured portions 42A, which are resiliently deformable in the connector width direction along with the first leg portions 15A, are also adapted such that a clearance dimensioned within the aforementioned allowable range is assured with respect to the first leg portions 15A even in the resiliently deformed state (see FIG. 6).

The upper plate portion 43 is provided extending in the terminal array direction along the bottom face of the bottom wall 33 of the movable housing 30. The upper plate portion 43 has a mounting plate portion 43A provided in the central area in the connector width direction and second contoured portions 43B provided on opposite sides of the mounting plate portion 43A in the connector width direction.

The mounting plate portion 43A has a plate-like configuration that is thicker than the second contoured portions 43B but thinner than the bottom plate portion 41, with the upper face thereof protruding upwardly of the second contoured portions 43B. As shown in FIG. 2, the mounting plate portion 43A has attachment aperture portions 43A-1 for attachment to the movable housing 30 formed extending through the mounting plate portion 43A in the up-down direction at multiple locations (3 locations in the present embodiment) corresponding to the attachment protrusions 33B of the movable housing 30. The attachment aperture portions 43A-1 are of a shape that matches the attachment protrusions 33B, i.e., a rectangular shape when viewed in the up-down direction. The dielectric member 40 is adapted to be attached to the movable housing 30 by press-fitting the respective attachment protrusions 33B into the corresponding attachment aperture portions 43A-1 from above.

As shown in FIG. 3, the second contoured portions 43B, which have a plate-like configuration of the same thickness dimensions as the lateral plate portions 42, couple the lateral edges of the top portion of the mounting plate portion 43A and the top ends of the first contoured portions. The second contoured portions 43B, which are positioned spaced by a slight clearance from the lower faces of the second leg portions 15B of the intermediate portions 15 of the socket terminals 10 in the up-down direction, extend in the connector width direction along the bottom faces of said second leg portions 15B. The clearance between the second contoured portions 43B and the second leg portions 15B is dimensioned to assure appropriate impedance in the socket terminals 10. Here, the value of the “appropriate impedance” is set within a predetermined allowable range and, accordingly, the aforementioned dimensions are set within a predetermined allowable range.

In the present embodiment, as described above, the first contoured portions 42A and the first leg portions 15A as well as the second contoured portions 43B and the second leg portions 15B are positioned spaced by a clearance dimensioned to assure appropriate impedance and are not in contact with one another. Accordingly, a good characteristic impedance match is achieved without an excessive drop in the characteristic impedance of the intermediate portions 15.

In the present embodiment, as shown in FIG. 3, the dielectric member 40 as a whole is provided in a spaced-apart relationship with respect to the interior surfaces of the stationary housing 20 and does not have sections overlapping with the stationary housing 20 when viewed in the terminal array direction. That is, the dielectric member 40 does not have sections abutting the stationary housing 20 in the terminal array direction. Accordingly, the dielectric member 40 as a whole is adapted to be capable of moving in the terminal array direction along with the movable housing 30 without interfering with the stationary housing 20.

The procedure of assembly of the socket connector 1 will be described next. First, the socket terminals 10 are attached to the movable housing 30 by press-fitting the movable-side retained portions 14 of the socket terminals 10 into the movable-side retaining portions 33A of the movable housing 30 from below. The dielectric member 40 is then attached to the movable housing 30 from below. Specifically, as shown in FIG. 4 (A), the dielectric member 40 is moved towards the bottom wall 33 of the movable housing 30 from below (see arrow in FIG. 4 (A)) and, as shown in FIG. 4 (B), the attachment protrusions 33B of the movable housing 30 are press-fitted into the attachment aperture portions 43A-1 of the dielectric member 40 from above.

Further, the movable housing 30 to which the socket terminals 10 and the dielectric member 40 are attached is introduced into the interior space 23 of the stationary housing 20 from below, and the stationary-side retained portions 12 of the socket terminals 10 are press-fitted into the stationary-side retaining portions 21A of the stationary housing 20. As a result, the socket terminals 10 are attached to the stationary housing 20, thereby completing the assembly of the socket connector 1.

The configuration of the plug connector 2, i.e., the counterpart connector, will be described next. The plug connector 2 has multiple plug terminals 50, which are made of sheet metal and serve as counterpart terminals, and a plug housing 60, which is made of plastic or other dielectric material (made of electrically insulating material) and retains the plug terminals 50. Polyamide (PA) or liquid crystal polymers (LCP) and other engineering plastics, etc., are suggested as examples of the dielectric material comprising the plug housing 60. As shown in FIG. 1 and FIG. 3, the plug terminals 50 are arranged in two rows such that the terminal array direction is the same direction (Y-axis direction) as the array direction of the socket terminals 10. The two rows of plug terminals 50 are disposed in a staggered pattern in alignment with the socket terminals 10.

The plug terminals 50, which are made by bending metal strip-like pieces in the through-thickness direction, are disposed such that the terminal width direction thereof coincides with the terminal array direction. As shown in FIG. 3, the plug terminals 50 have a connecting portion 51 formed at one end (top end in FIG. 3), a contact arm portion 52 formed at the other end (bottom end in FIG. 3), and a coupling portion 53 bent in a stepped configuration between the connecting portion 51 and the contact arm portion 52.

The configuration of the plug housing 60 will be described before describing the plug terminals 50 further. As shown in FIG. 1, the plug housing 60 has a rectangular parallelepiped-like external shape whose longitudinal direction is the terminal array direction (Y-axis direction). The plug housing 60 has a pair of lateral walls 61 extending in the terminal array direction and a pair of end walls 62 extending in the connector width direction (X-axis direction) and coupling the end portions of the pair of lateral walls 61, with the pair of lateral walls 61 and the pair of end walls 62 forming a peripheral wall. As shown in FIG. 3, an interior space formed as a result of being enclosed by this peripheral wall is separated into upper and lower parts by an intervening wall 63 provided at an intermediate location in the up-down direction and is adapted to be capable of receiving a portion of the socket connector 1 in a plug-side receiving portion 64, i.e., the lower interior space. In addition, a protruding wall 65, which protrudes downwardly from the lower face of the intervening wall 63 while extending in the terminal array direction, is provided within the plug-side receiving portion 64. Plug terminal groove portions 65A, which are recessed into the lateral faces of the protruding wall 65 while extending in the up-down direction, are formed in a side-by-side arrangement in the bottom portion of the protruding wall 65.

Going back to the description of the plug terminals 50, the connecting portions 51, which are located upwardly of the bottom face of the plug housing 60 (upper face in FIG. 3) and extend outwardly in the connector width direction from the top ends of the coupling portions 53, are adapted to be solder-connected to corresponding circuits on the mounting face of the circuit board (not shown). The contact arm portions 52 are of the same shape as the contact arm portions 13 of the socket terminals 10. As shown in FIG. 3, the contact arm portions 52, which extend downwardly from the bottom ends of the coupling portions 53 along the lateral faces of the protruding wall 65 of the plug housing 60, are adapted to be resiliently deformable in the connector width direction (in the through-thickness direction of the contact arm portions 52). Specifically, as shown in FIG. 3, the top portions of the contact arm portions 52, which are in surface contact with the lateral faces of the protruding wall 65, are supported from the inside in the connector width direction by said lateral faces. The bottom portions of the contact arm portions 52, as shown in FIG. 3, are positioned in alignment with the plug terminal groove portions 65A of the protruding wall 65 in the up-down direction, and the resilient deformation thereof directed inwardly in the connector width direction is permitted by the plug terminal groove portions 65A when placed in contact with the socket terminals 10. Contact portions 52A intended for contacting the socket terminals 10 are formed in the bottom end portions of the contact arm portions 52 by being bent so as to protrude outwardly in the connector width direction.

The plug terminals 50 are attached to said plug housing 60 from the side of the bottom face (upper face side in FIG. 3) of the plug housing 60. Specifically, while the bottom end portions of the coupling portions 53 are press-fittingly retained by plug terminal retaining aperture portions 63A formed through the intervening wall 63, the top end portions of the coupling portions 53 are press-fittingly retained by plug terminal retaining groove portions 61A recessed from the interior wall surfaces of the lateral walls 61.

The operation of mating of the socket connector 1 and plug connector 2 will be described next. First, the socket connector 1 and plug connector 2 are mounted to the mounting faces of the respectively corresponding circuit boards (not shown) using solder connections. Namely, the connecting portions 11 of the socket terminals 10 are solder-connected to corresponding circuits on one circuit board and the connecting portions 51 of the plug terminals 50 are solder-connected to corresponding circuits on the other circuit board, thereby attaching the socket connector 1 and plug connector 2 to the respectively corresponding circuit boards.

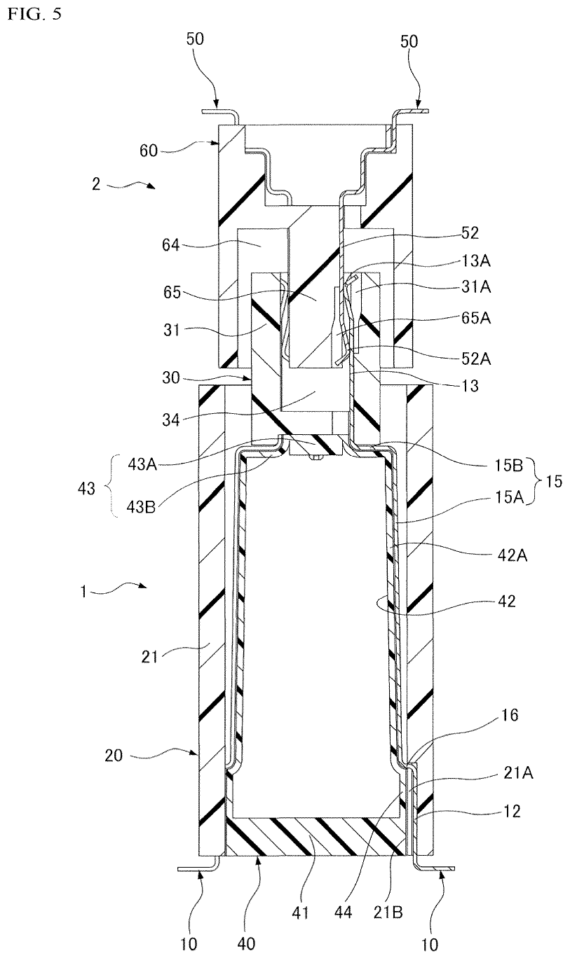

Next, as shown in FIG. 1 and FIG. 3, the plug connector 2 is positioned above the socket connector 1 in an orientation wherein the plug-side receiving portion 64 (see FIG. 3) is downwardly open. The plug connector 2, while being held in that orientation, is lowered, and the protruding wall 65 is introduced into the socket-side receiving portion 34 of the movable housing 30 of the socket connector 1 from above. At the same time, the peripheral wall of the movable housing 30 enters the plug-side receiving portion 64 of the plug connector 2 from below. As a result, as shown in FIG. 5, the socket connector 1 and plug connector 2 are mated.

When the plug connector 2 is mated with the socket connector 1, as shown in FIG. 5, the contact arm portions 13 of the socket terminals 10, while undergoing resilient deformation, make contact with the top portions, i.e., the proximal sections, of the contact arm portions 52 of the plug terminals 50 under contact pressure using the contact portions 13A. In addition, the contact arm portions 52 of the plug terminals 50, while undergoing resilient deformation, make contact with bottom portions, i.e., the proximal sections, of the contact arm portions 13 of the socket terminals 10 under contact pressure using the contact portions 52A. Namely, as shown in FIG. 5, the socket terminals 10 and the plug terminals 50 are placed in 2-point contact and are in electrical communication. Since in the present embodiment the top portions of the contact arm portions 52 are supported by the protruding wall 65 of the plug housing 60 and, in addition, the bottom portions of the contact arm portions 13 are supported by the long walls 31 of the movable housing 30, the socket terminals 10 and plug terminals 50 are placed in contact with one another under sufficiently high contact pressure. This completes the operation of mating connection of the socket connector 1 and plug connector 2.

If there is no misalignment in the relative positions of the socket connector 1 and plug connector 2 at the moment of completion of the operation of mating connection, the socket connector 1 and plug connector 2 will be in the standard position illustrated in FIG. 5. In this standard position, the first leg portions 15A of the socket terminals 10 are positioned to have a predetermined clearance from the interior wall surfaces of the lateral walls 21 of the stationary housing 20 in the connector width direction. The second leg portions 15B of the socket terminals 10 are positioned to have a predetermined clearance from the bottom face of the bottom wall 33 of the movable housing 30 in the up-down direction. In addition, the first contoured portions 42A of the dielectric member 40 are positioned to have a predetermined clearance from the interior wall surfaces of the first leg portions 15A of the socket terminals 10 in the connector width direction. The second contoured portions 43B of the dielectric member 40 are positioned to have a predetermined clearance from the lower faces of the second leg portions 15B of the socket terminals 10 in the up-down direction.

Even if the relative positions of the socket connector 1 and plug connector 2 are misaligned immediately prior to the start of the operation of mating connection of the connectors, in the process of connector mating and after connector mating, the movable housing 30 moves (floats) towards the direction in which the misalignment has taken place and, as a result, makes mating connection possible upon absorption of the misalignment (see FIG. 6).

In addition, even if the socket connector 1 and plug connector 2 are in the standard position (see FIG. 5) at the moment of completion of the operation of mating connection, when the connectors are later used, for example, in a vibration-generating environment, their vibration is absorbed by the floating action of the movable housing 30 of the socket connector 1.

FIG. 6 is a cross-sectional view of the socket connector 1 and plug connector 2 after mating connection, with the movable housing 30 shown in a floating state. FIG. 6 illustrates a cross-section taken in a plane perpendicular to the terminal array direction at the location of a socket terminal 10. In addition, FIG. 6 illustrates a state in which the movable housing 30 is floating in the connector width direction (X-axis direction) toward the X1 side. If the movable housing 30 floats toward the X1 side, the first leg portions 15A of the two socket terminals 10 illustrated in FIG. 6, i.e., the two socket terminals 10 located on the X1 side and on the X2 side, are resiliently deformed so as to be tilted toward the X1 side, with locations in proximity to the bottom end portions of said first leg portions 15A serving as fulcrum points. At such time, the first leg portion 15A of the socket terminal 10 on the X1 side undergoes resilient deformation within the range of the clearance formed with the interior wall surface of the lateral wall 21 of the stationary housing 20.

As shown in FIG. 6, when the movable housing 30 floats toward the X1 side in the connector width direction, the dielectric member 40 attached to said movable housing 30, in its entirety, first moves slightly toward the X1 side along with the movable housing 30 and abuts the restricting portion 21B of the stationary housing 20 on the X1 side with the restricted portion 44 on the X1 side. Since the restricted portion 44 abuts the restricting portion 21B on the X1 side in this manner, the movement of the dielectric member 40 as a whole is restricted. At such time, on the X2 side, the restricted portion 44 moves away from the restricting portion 21B and, therefore, the restricted portion 44 does not abut the restricting portion 21B.

As shown in FIG. 6, when the movable housing 30 moves further toward the X1 side, the first contoured portion 42A of the dielectric member 40 on the X1 side is resiliently deformed so as to be tilted toward the X1 side in concert with the resilient deformation of the first leg portion 15A of the socket terminal 10 on the X1 side, with the location of abutment of the restricted portion 44 and the restricting portion 21B serving as a fulcrum point. At such time, the first contoured portion 42A on the X2 side follows the resilient deformation of the first leg portion 15A on the X2 side and is resiliently deformed toward the X1 side.

In the present embodiment, as described above, when the movable housing 30 floats in the connector width direction, the two first contoured portions 42A of the dielectric member 40 are resiliently deformed in the connector width direction along with the first leg portions 15A adjacent to said first contoured portions 42A. In this manner, the first contoured portions 42A are adapted to be capable of following the first leg portions 15A and, therefore, do not interfere with the resilient deformation of the first leg portions 15A and, by extension, the movement of the movable housing 30.

In addition, even in a resiliently deformed state, the first contoured portions 42A maintain a clearance from the first leg portions 15A in the previously discussed predetermined allowable range and do not come into contact with the first leg portions 15A. In addition, as shown in FIG. 6, neither the second leg portions 15B of the socket terminals 10 nor the second contoured portions 43B of the dielectric member 40 are resiliently deformed when floating in the connector width direction. Accordingly, the second leg portions 15B and second contoured portions 43B do not come into contact because the clearance therebetween in the up-down direction is maintained.

Even if the movable housing 30 floats in this manner, the clearance formed between the first contoured portions 42A and the second contoured portions 43B of the dielectric member 40 and the intermediate portions 15 of the socket terminals 10 is maintained. Accordingly, the characteristic impedance of the intermediate portions 15 does not drop too low and the characteristic impedance match achieved in the socket terminals 10 can thus be maintained.

In addition, in the present embodiment, as described above, the first contoured portions 42A of the dielectric member 40 are resiliently deformed in concert with the movement of the movable housing 30 along with the first leg portions 15A of the socket terminals 10, with the locations of abutment of the restricted portions 44 of the dielectric member 40 and the restricting portions 21B of the stationary housing 20 serving as fulcrum points. Accordingly, it becomes easier to maintain an assured clearance therebetween and, by extension, a good characteristic impedance match even in the resiliently deformed state of the first contoured portions 42A and first leg portions 15A.

In addition, if the movable housing 30 floats in the terminal array direction, the floating action thereof is permitted due to the fact that the intermediate portions 15 of the socket terminals 10 undergo resilient deformation in the terminal array direction. In the present embodiment, the dielectric member 40 does not have sections abutting the stationary housing 20 in the terminal array direction. Accordingly, the dielectric member 40 as a whole does not interfere with the stationary housing 20 in the terminal array direction and, therefore, can smoothly follow the movement of the movable housing 30.

At such time, the first contoured portions 42A themselves and second contoured portions 43B themselves move in concert with the resiliently deformed intermediate portions 15 while being free of resilient deformation in the terminal array direction and keeping the intermediate portions 15 of the socket terminals 10 covered. In the present embodiment, the first contoured portions 42A and second contoured portions 43B are formed to be continuously solid over the entire extent thereof in the terminal array direction and, therefore, reliably cover the intermediate portions 15 even when the intermediate portions 15 are resiliently deformed in the terminal array direction, as a result of which a good characteristic impedance match can be assured in the socket terminals 10.

### Second Embodiment

While in the first embodiment the first contoured portions 42A and second contoured portions 43B are formed to be continuously solid over the entire extent thereof in the terminal array direction, in the second embodiment, the first contoured portions and second contoured portions have slits formed therein at predetermined intervals in the terminal array direction, as a consequence of which they are rendered discontinuous in the terminal array direction and, in this respect, the configuration is made different from the first embodiment. In the present embodiment, the emphasis is on differences from the first embodiment, and sections identical to the first embodiment are assigned reference numerals obtained by adding “100” to the reference numerals used in the first embodiment and further discussion thereof is omitted.

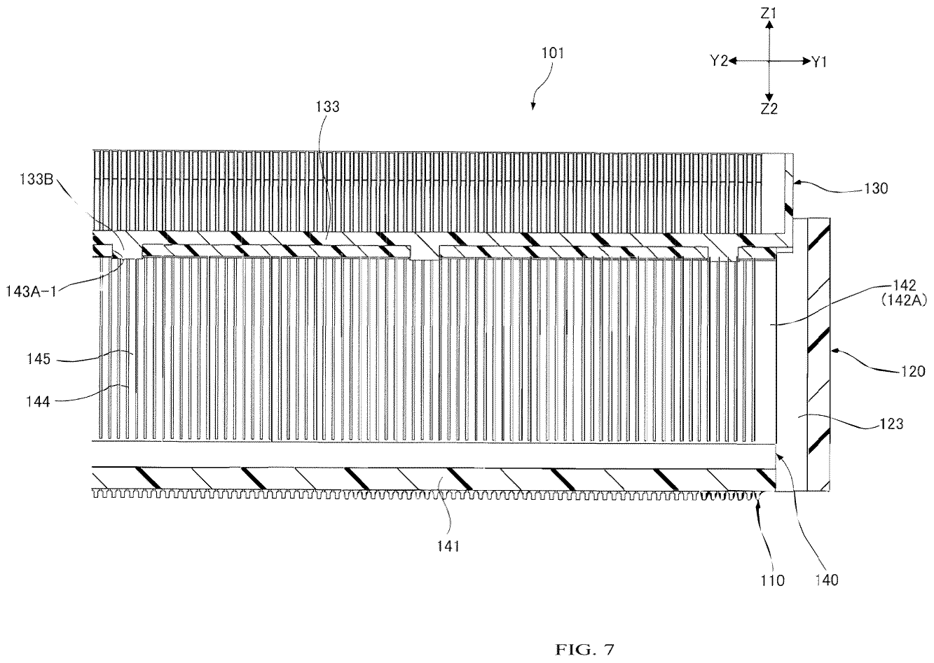

FIG. 7 is a cross-sectional view illustrating a cross-section of a socket connector 101 according to the second embodiment of the present invention taken in a plane perpendicular to the connector width direction. FIG. 7 shows a cross-section taken at the center of the socket connector 101 in the connector width direction. In addition, in FIG. 7, the illustration of the end portion on the Y2 side in the terminal array direction (Y-axis direction) is omitted. In the present embodiment, the bottom portion of the dielectric member 140 is secured to the bottom portion of the stationary housing 120 and, in this respect, the configuration differs from the socket connector 1 of the first embodiment, in which the dielectric member 40 is not secured to the stationary housing 20.

As shown in FIG. 7, slits 144 are formed in the first contoured portions 142A and second contoured portions (not shown in FIG. 7) of the dielectric member 140 at locations between every two socket terminals 110 in the terminal array direction. The slits 144, which extend continuously over substantially the entire extent of the first contoured portions 142A in the up-down direction (Z-axis direction) as well as substantially the entire extent of the second contoured portions in the connector width direction (X-axis direction), are formed in the through-thickness direction of the first contoured portions 142A and second contoured portions. As a result, thin strips 145 are formed on opposite sides of each slit 144 in the terminal array direction in the first contoured portions 142A and second contoured portions. The thin strips 145 are formed to substantially the same width dimensions as the intermediate portions of the socket terminals 110 (not shown in FIG. 7). Accordingly, the thin strips 145 cover the intermediate portions positioned in alignment with said thin strips 145 from below and from the inside in the connector width direction.

In the present embodiment, the first contoured portions 142A and second contoured portions are formed of multiple thin strips 145 and are discontinuous in the terminal array direction. Accordingly, in comparison with the first embodiment, in which the first contoured portions 42A and second contoured portions 43B are formed to be continuously solid over the entire extent thereof in the terminal array direction, in the present embodiment, the first contoured portions 142A and second contoured portions become more resiliently deformable in the connector width direction, which facilitates the floating action of the movable housing 130 in this direction.

In addition, in the present embodiment, along with being secured to the movable housing 130 with the top portion thereof, the dielectric member 140 is secured to the stationary housing 120 with the bottom portion thereof. Accordingly, when the intermediate portions of the socket terminals 110 are resiliently deformed in the terminal array direction as the movable housing 130 floats in the terminal array direction, the thin strips 145 of the dielectric member 140 are resiliently deformed in the terminal array direction in concert with the intermediate portions. Accordingly, even if the movable housing 130 floats, the thin strips 145 of the dielectric member 140 keep covering the intermediate portions of the socket terminals 110. In addition, at such time, the predetermined clearance formed between the thin strips 145 and the intermediate portions is also maintained. As a result, a good characteristic impedance match can be assured in the socket terminals 110.

### Third Embodiment

Although in the first embodiment the overall shape of the intermediate portions 15 of the socket terminals 10 had a generally inverted L-shaped configuration, the shape of the intermediate portions is not limited thereto. In a third embodiment, sections curved in a generally S-shaped configuration are present in part of the intermediate portions of the socket terminals and, in this respect, the configuration is different from the first embodiment. In the present embodiment, the emphasis is on differences from the first embodiment, and sections identical to the first embodiment are assigned reference numerals obtained by adding “200” to the reference numerals used in the first embodiment and further discussion thereof is omitted.

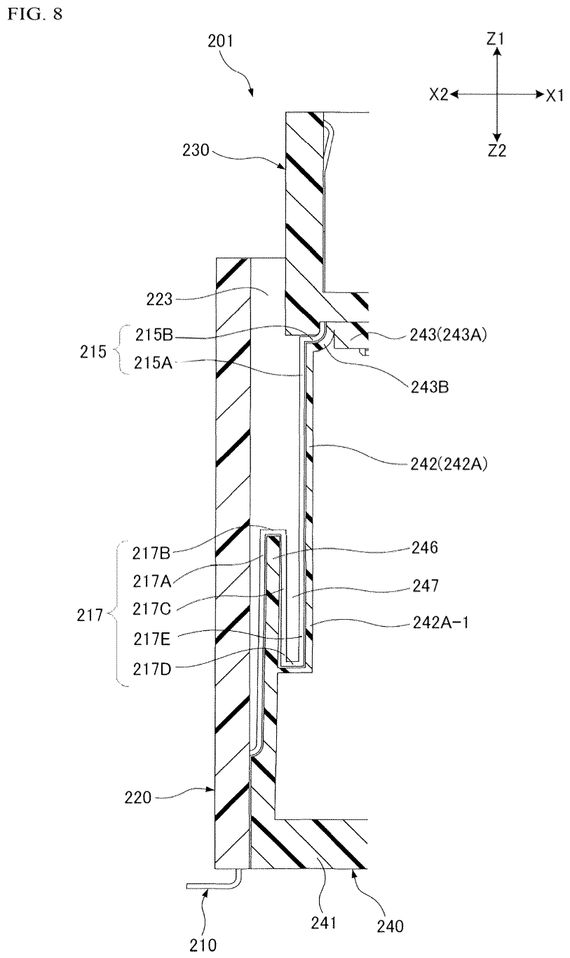

FIG. 8 is a cross-sectional view illustrating a cross-section of a socket connector 201 according to the third embodiment of the present invention taken in a plane perpendicular to the terminal array direction. In FIG. 8, the illustration of the half on the X1 side in the connector width direction is omitted. As shown in FIG. 8, in the present embodiment, the first leg portions 215A of the intermediate portions 215 of the socket terminals 210, in the bottom portions thereof, have resiliently deformable curved resilient portions 217 bent in a generally horizontal S-shaped configuration. The curved resilient portions 217 have an exterior leg portion 217A, an intermediate leg portion 217C, and an interior leg portion 217E extending in the up-down direction as well as an upper bend portion 217B and a lower bend portion 217D, each of which couples two of these leg portions.

Specifically, in an order from the outside in the connector width direction, there are provided, side by side, the exterior leg portion 217A, the intermediate leg portion 217C, and the interior leg portion 217E, with the top ends of the exterior leg portion 217A and the intermediate leg portion 217C coupled by the upper bend portion 217B and the bottom ends of the intermediate leg portion 217C and the interior leg portion 217E coupled by the lower bend portion 217D. In the present embodiment, providing a curved resilient portion 217 in part of the first leg portion 215A in this manner makes it possible to ensure a greater spring length for the first leg portion 215A without increasing the dimensions of the first leg portion 215A in the up-down direction.

In addition, as shown in FIG. 8, the first contoured portions 242A of the dielectric member 240 have a projecting portion 246 projecting upwardly up to a location directly underneath the upper bend portion 217B between the exterior leg portion 217A and the intermediate leg portion 217C. The projecting portion 246 is positioned spaced by a clearance of predetermined dimensions from the exterior leg portion 217A, the upper bend portion 217B, and the intermediate leg portion 217C. This clearance is dimensioned to assure appropriate impedance in the socket terminals 210. Here, the value of the “appropriate impedance” is set within a predetermined allowable range and, accordingly, the aforementioned dimensions are set within a predetermined allowable range.

The projecting portion 246, which is formed in part of the resiliently deformable first contoured portion 242A, is adapted to be capable of displacement in the connector width direction along with a generally inverted U-shaped section formed by the exterior leg portion 217A, the upper bend portion 217B, and the intermediate leg portion 217C. When the aforementioned generally inverted U-shaped section is resiliently deformed, the projecting portion 246 is displaced in concert with said generally inverted U-shaped section. As a result, even in the resiliently deformed state of the generally inverted U-shaped section, a clearance dimensioned within the aforementioned allowable range is assured between the generally inverted U-shaped section and the projecting portion 246.

In addition, as shown in FIG. 8, an upwardly open recessed portion 247 is formed between the projecting portion 246 and another part of the first contoured portion 242A, specifically section 242A-1, which is positioned inwardly of the projecting portion 246 in the connector width direction and within the same range as the projecting portion 246 in the up-down direction. The recessed portion 247 accommodates a generally U-shaped section formed by the intermediate leg portion 217C, the lower bend portion 217D, and the interior leg portion 217E. This generally U-shaped section is spaced by a clearance of predetermined dimensions from the interior wall surfaces of the recessed portion 247. This clearance is dimensioned to assure appropriate impedance in the socket terminals 210. Here, the value of the “appropriate impedance” is set within a predetermined allowable range and, accordingly, the aforementioned dimensions are set within a predetermined allowable range. Even in the resiliently deformed state of the aforementioned generally U-shaped section, a clearance dimensioned within the aforementioned allowable range is assured between said generally U-shaped section and the interior wall surfaces of the recessed portion 247.

In addition, in the present embodiment, as shown in FIG. 8, the second leg portions 215B of the socket terminals 210 are shorter than the second leg portions 15B of the first embodiment (see FIG. 5) and, accordingly, the second contoured portions 243B of the dielectric member 240 are also shorter than the second contoured portions 43B of the first embodiment (see FIG. 5).

### Fourth Embodiment

Although in the first embodiment the socket connector 1 was matingly connected to the plug connector 2, i.e., the counterpart connector, such that the direction of connection was a direction perpendicular to the mounting face of the circuit board to which said socket connector 1 was mounted, in the fourth embodiment, it is adapted to be matingly connected to a plug connector, i.e., a counterpart connector, such that the direction of connection is a direction parallel to the mounting face of the circuit board, and, in this respect, the configuration is different from the first embodiment. In the present embodiment, the emphasis is on differences from the first embodiment, and sections identical to the first embodiment are assigned reference numerals obtained by adding “300” to the reference numerals used in the first embodiment and further discussion thereof is omitted.

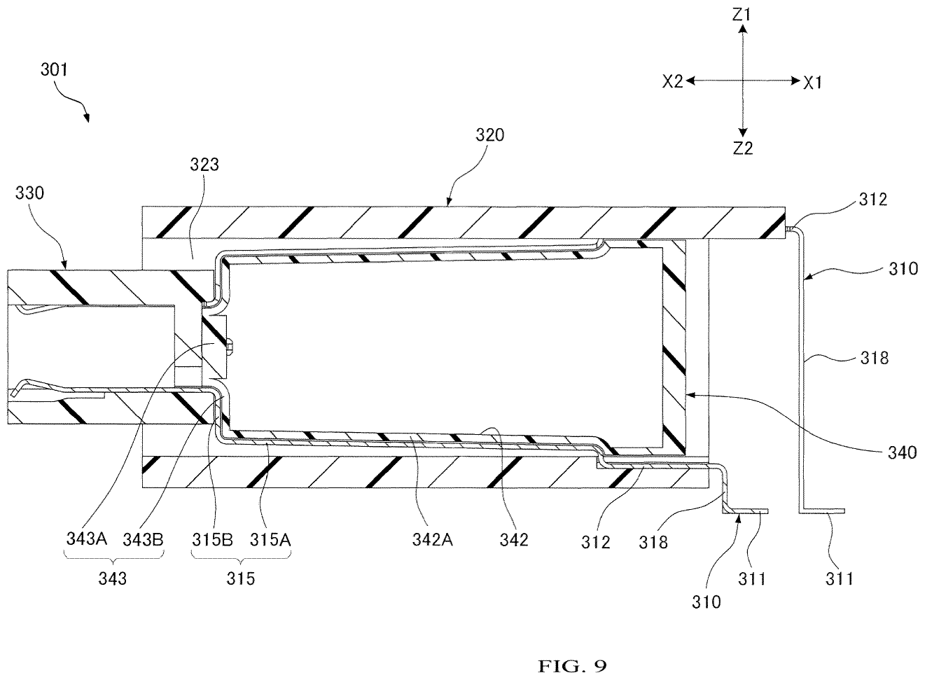

FIG. 9 is a cross-sectional view illustrating a cross-section of a socket connector 301 according to the fourth embodiment of the present invention taken in a plane perpendicular to the terminal array direction. FIG. 9 illustrates a cross-section taken at the location of socket terminals 310 in the terminal array direction (Y-axis direction). As shown in FIG. 9, in the present embodiment, the socket connector 301 is adapted to be matingly connected to a plug connector (not shown), i.e., a counterpart connector, such that the direction of connection is a left-to-right direction (X-axis direction in FIG. 9) parallel to the mounting face of the circuit board (not shown).

The socket connector 301 of the present embodiment is configured by laying the socket connector 1 of the first embodiment (see FIG. 3) on its side and extending one end section on the side where the connecting portions 11 are provided in the socket terminals 10. As shown in FIG. 9, in the present embodiment, extension portions 318, which are bent at the right ends (ends on the X1 side) of the stationary-side retained portions 312 and extend downwardly in a rectilinear manner, are provided in the socket terminals 310, and connecting portions 311 are provided extending to the right from the bottom ends of the extension portions 318. As shown in FIG. 9, the extension portion 318 of the upper (Z1-side) socket terminal 310 is positioned to the right (on the X1 side) of the extension portion 318 of the lower (Z2-side) socket terminal 310 and has a greater length than said extension portion 318.

In the socket connector 301 of the present embodiment, in the same manner as in the first embodiment, the clearance between the first contoured portions 342A of the dielectric member 340 and the first leg portions 315A of the socket terminals 310 as well as between the second contoured portions 343B of the dielectric member 340 and the second leg portions 315B of the socket terminals 310 is dimensioned to assure appropriate impedance in the socket terminals 310. The clearance formed between the first contoured portions 342A and the first leg portions 315A as well as between the second contoured portions 343B and the second leg portions 315B is maintained even when the movable housing 330 is in a floating state.

Although in the previously discussed first through fourth embodiments the dielectric member is accommodated in its entirety within the interior space formed in the stationary housing, as a substitute variation, only part of the dielectric member may be accommodated therein. In addition, although in the first through fourth embodiments the dielectric member is accommodated in the interior space of the stationary housing, as a substitute variation, an interior space may be formed in the movable housing and the dielectric member may be accommodated within such an interior space.

Although in the first through fourth embodiments the dielectric member was attached to the movable housing, as a substitute variation, the dielectric member may be attached to the stationary housing and not to the movable housing. In this variation, restricted portions formed in part of the dielectric member are adapted to be abuttable against restricting portions formed in the movable housing in the connector width direction. As a result, when the movable housing floats in the connector width direction, the restricted portions abut the restricting portions, as a consequence of which the first contoured portions of the dielectric member are resiliently deformed in the connector width direction in concert with the socket terminals. In addition, in this variation, the dielectric member may have no sections abutting the movable housing in the terminal array direction. In such a case, the dielectric member does not move along with the movable housing even if the movable housing floats in the terminal array direction.

Although in the first through fourth embodiments the contoured portions of the dielectric member are resiliently deformed when following the intermediate portions of the socket terminals, it is not essential for the contoured portions to be resiliently deformed, and they may be adapted to be displaced without attendant resilient deformation.

### DESCRIPTION OF THE REFERENCE NUMERALS

1, 101, 201, 301 Socket connector (electrical connector for circuit boards)
10, 110, 210, 310 Socket terminals
12, 312 Stationary-side retained portion
14 Movable-side retained portion
15, 215, 315 Intermediate portion
20, 120, 220, 320 Stationary housing
23, 123, 223, 323 Interior space
30, 130, 230, 330 Movable housing
40, 140, 240, 340 Dielectric member
42A, 142A, 242A, 342A First contoured portion
43B, 243B, 343B Second contoured portion
44 Restricted portion

1. An electrical connector for circuit boards disposed on a mounting face of a circuit board,
said electrical connector having a plurality of terminals arranged such that the terminal array direction is a direction parallel to the mounting face, a stationary housing secured to the circuit board through the medium of the terminals, and a movable housing capable of relative movement with respect to the stationary housing, and
the terminals having a stationary-side retained portion retained in the stationary housing, a movable-side retained portion retained in the movable housing, and a resiliently deformable intermediate portion located between the stationary-side retained portion and the movable-side retained portion, and being provided spanning between the stationary housing and the movable housing, wherein:
said electrical connector has a dielectric member that is at least partially disposed in an interior space formed in at least one of the stationary housing and the movable housing and is attached to the stationary housing or the movable housing,
the dielectric member has contoured portions extending along the intermediate portions while being spaced by a clearance from the intermediate portions, and
the contoured portions are capable of following the intermediate portions when the intermediate portions are resiliently deformed in the connector width direction perpendicular to the terminal array direction.

2. The electrical connector for circuit boards according to claim 1, wherein the dielectric member is attached to the movable housing, and has restricted portions abuttable against the stationary housing in the connector width direction at locations other than the contoured portions.

3. The electrical connector for circuit boards according to claim 1, wherein the dielectric member has no sections abutting the stationary housing in the terminal array direction, and the dielectric member as a whole is capable of moving in the terminal array direction along with the movable housing.

4. The electrical connector for circuit boards according to claim 2, wherein the dielectric member has no sections abutting the stationary housing in the terminal array direction, and the dielectric member as a whole is capable of moving in the terminal array direction along with the movable housing.
